(19) United States
(12) Patent Application Publication
(10) Pub. No.: US 2008/0192149 A1
(43) Pub. Date: Aug. 14, 2008

(54) Digital TV receiver with a built-in antenna

(76) Inventor: Tseng-Chieh Lee, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/068,369

(22) Filed: Feb. 6, 2008

(30) Foreign Application Priority Data
Feb. 12, 2007 (TW) 96202672

(51) Int. Cl. H04N 5/44

(52) U.S. Cl. 348/725

(57) ABSTRACT

A digital TV receiver with a built-in antenna includes a casing unit, a circuit unit, an output unit, an antenna unit and a protection cover. The circuit unit is disposed inside the casing unit. The output unit is electrically connected to the circuit unit and exposed outside the casing unit. The antenna unit has a rotation element pivoting around the casing unit and an antenna disposed inside the rotation element and electrically connected to the circuit unit. The rotation element is rotatably positioned at a first position close to the output unit and a second position far away from the output unit. The protection cover mates with the casing unit for covering the output unit. The first position is a retaining position for making the protection cover retained on the casing unit. The second position is an inclined position for making the rotation element inclined relative to the casing unit.

### BACKGROUND OF THE INVENTION

1. Field of the Invention

The present invention relates to a digital TV receiver, and particularly relates to a digital TV receiver with a built-in antenna.

2. Description of the Related Art

Digital TV is a new wireless TV technology, and its texts and images are digital, that is coded in zeros and ones, the same as in computers. Hence, the user can store and adjust frame and information that user wants. Noise is reduced and the sound and picture quality is better (similar to DVD) due to digital wireless transmission. Originally one TV station can provide one channel; now one TV station can provide three or four different channels due to the image compression technology.

Referring to FIG. 1, when a digital TV receiver R of the prior art is inserted into a notebook N, the digital TV receiver R has an antenna A for receiving digital TV signals. In addition, the digital TV signals need to be decoded via the digital TV receiver R in order to output digital TV programs from the digital TV receiver R into the notebook N to display.

However, the antenna A of the prior art is exposed outside the digital TV receiver R, so that it is difficult and inconvenient for user to receive the antenna A and carry the digital TV receiver R.

### SUMMARY OF THE INVENTION

One particular aspect of the present invention is to provide a digital TV receiver with a built-in antenna. The digital TV receiver makes an antenna disposed inside a rotation element. The rotation element can be received by rotating or moving the rotation element. In other words, because the antenna is disposed inside the rotation element, it is easy for user to receive the antenna by control the rotation element.

In order to achieve the above-mentioned aspects, the present invention provides a digital TV receiver with a built-in antenna that includes a casing unit, a circuit unit, an output unit, an antenna unit and a protection cover. The circuit unit is disposed inside the casing unit. The output unit is electrically connected to the circuit unit and exposed outside the casing unit. The antenna unit has a rotation element pivoting around the casing unit and an antenna disposed inside the rotation element and electrically connected to the circuit unit. The rotation element is rotatably positioned at a first position close to the output unit and a second position far away from the output unit.

Moreover, the protection cover is mated with the casing unit for covering the output unit. The first position is a retaining position for making the protection cover retained on the casing unit, and the rotation element is selectively positioned at the retaining position. The second position is an inclined position for making the rotation element inclined relative to the casing unit, and the rotation element is selectively positioned at the inclined position.

Therefore, it is easy for user to use and receive the antenna of the digital TV receiver due to the design of the rotation element.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

FIG. 1 is a perspective, schematic view of a digital TV receiver in use according to the prior art;

FIG. 2 is a perspective, schematic view of a digital TV receiver that has a closed protection cover according to the first embodiment of the present invention;

FIG. 3 is a perspective, schematic view of a digital TV receiver that has an opened protection cover according to the first embodiment of the present invention;

FIG. 4 is a perspective, schematic view of a digital TV receiver in use according to the first embodiment of the present invention;

FIG. 5 is a perspective, schematic view of a digital TV receiver that has a closed protection cover according to the second embodiment of the present invention;

FIG. 6 is a first perspective, schematic view of a digital TV receiver that has an opened protection cover according to the second embodiment of the present invention;

FIG. 7 is a second perspective, schematic view of a digital TV receiver that has an opened protection cover according to the second embodiment of the present invention; and

FIG. 8 is a perspective, schematic view of a digital TV receiver in use according to the second embodiment of the present invention.

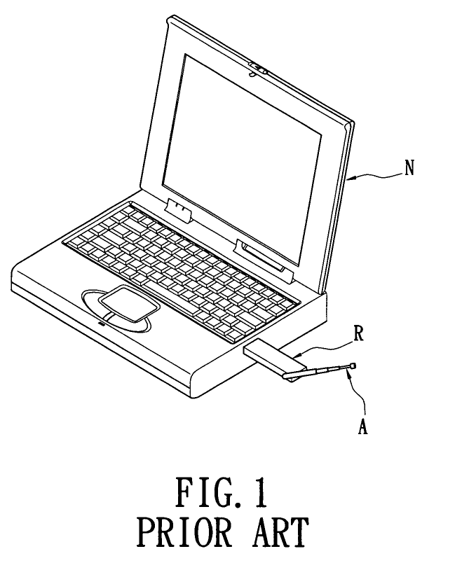

### DETAILED DESCRIPTION OF THE PREFERRED EMBODIMENTS

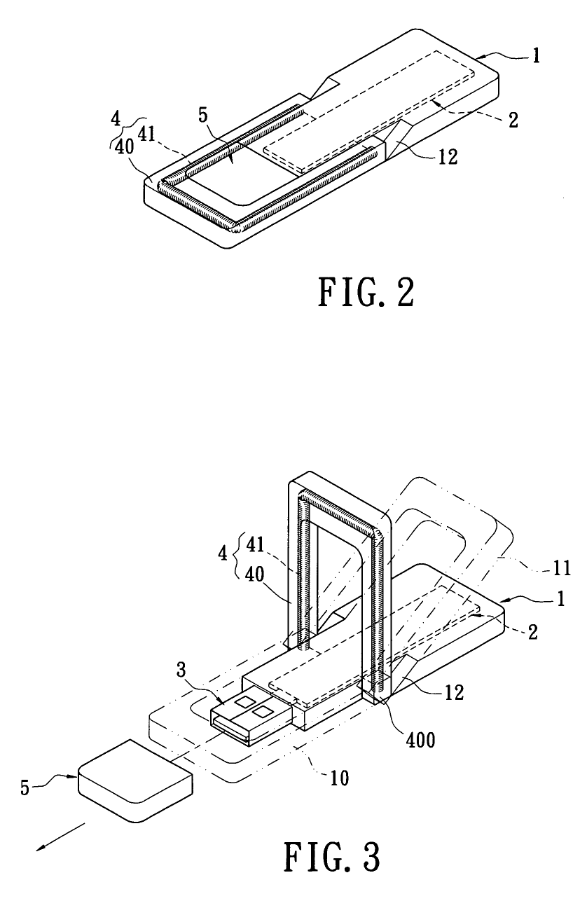

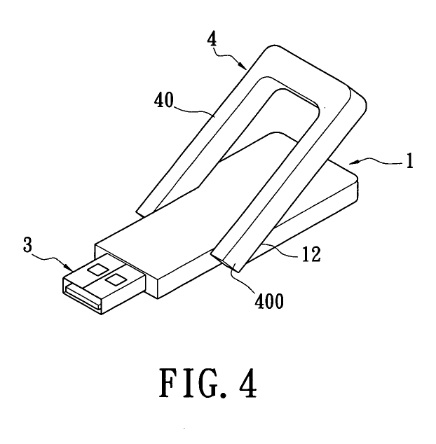

Referring to FIGS. 2 to 4, the first embodiment of the present invention provides a digital TV receiver with a built-in antenna that includes a casing unit 1, a circuit unit 2, an output unit 3, an antenna unit 4 and a protection cover 5.

The circuit unit 2 is disposed inside the casing unit 1. The output unit 3 is electrically connected to the circuit unit 2. The output unit 3 is disposed on one side of the casing unit 1 and is exposed outside the casing unit 1. Hence, the digital TV receiver can electrically connect to a computer system (not shown) via the output unit 3 in order to transmitting digital TV signals. In the first embodiment, the output unit 3 can be a USB connector. In other embodiment, the output unit 3 can be other interface connector such as IEEE1394 interface, RS232 interface or Mini USB interface.

Moreover, the antenna unit 4 has a rotation element 40 pivoting around the casing unit 1 and an antenna 41 disposed inside the rotation element 40, and the antenna unit 4 is electrically connected to the circuit unit 2. The rotation element 4 has a U shape. The rotation element 4 has a pair of side arms 400, and the rotation element 4 pivots around the casing unit 1 via the pair of side arms 400.

Furthermore, in the first embodiment the protection cover 5 is mated with the casing unit 1 for covering the output unit 3. In other words, the protection cover 5 is directly mated with the output unit 3 in order to cover the output unit 3.

In addition, the rotation element 4 is rotatably positioned at a first position close to the output unit 3 and a second position far away from the output unit 3. In the first embodiment, the first position is a retaining position 10 for making the protection cover 5 retained on the casing unit 1, and the rotation element 4 can be selectively positioned at the retaining position 10. The second position is an inclined position 11 for making the rotation element 4 inclined relative to the casing unit 1, and the rotation element 4 is selectively positioned at the inclined position 11. Furthermore, the casing unit 1 has a pair of inclined blocks 12 for making the rotation element 4 positioned at the inclined position 11.

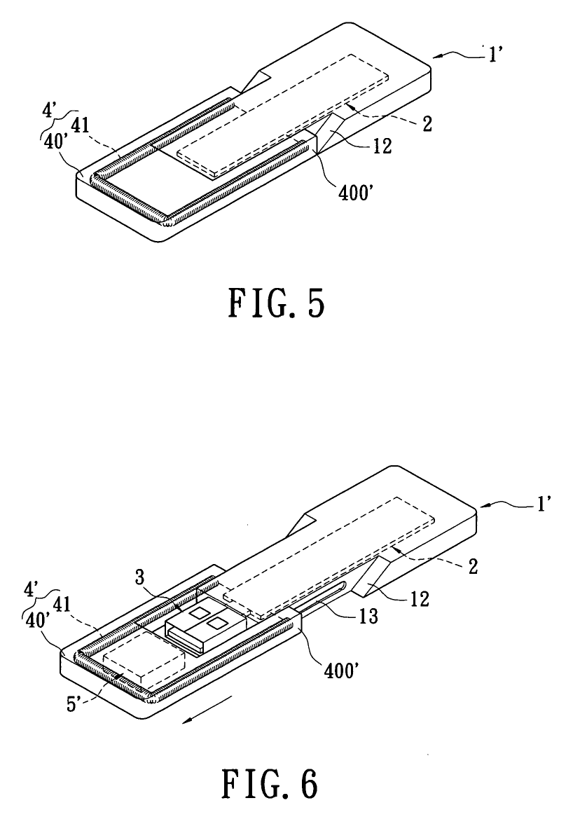

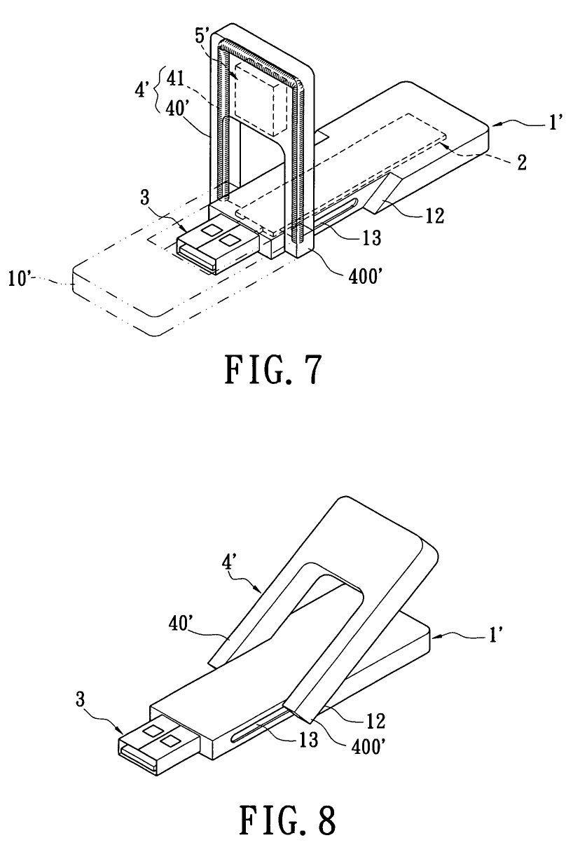

Referring to FIGS. 5 to 8, the second embodiment of the present invention provides a digital TV receiver with a built-in antenna that includes a casing unit 1′, a circuit unit 2, an output unit 3, an antenna unit 4′ and a receiving space 5′.

The difference between the second embodiment and the first embodiment is that: the casing unit 1′ has two sliding slots 13 respectively formed on two sides thereof, and the rotation element 40′ of the antenna unit 4′ has two sliding sides 400′ respectively disposed on the same end sides and slidably receiving in the two sliding slots 13. In addition, the receiving space 5′ of the rotation element 40′ is formed on another opposite end side for mating with the casing unit 1′ and receiving the output unit 3. Hence, the first position is a covering position 10′ for making the output unit 3 received in the receiving space 5′ of the rotation element 40′, and the rotation element 40′ is selectively positioned at the covering position 10′. The second position of the second embodiment is the same as the second position of the first embodiment.

In conclusion, the digital TV receiver of the present invention makes the antenna 41 disposed inside the rotation element (40 or 40′). The rotation element (40 or 40′) can be received by rotating or moving the rotation element (40 or 40′). In other words, because the antenna 41 is disposed inside the rotation element (40 or 40′), it is easy for user to receive the antenna 41 by control the rotation element (40 or 40′).

Although the present invention has been described with reference to the preferred best molds thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A digital TV receiver with a built-in antenna, comprising:
a casing unit;
a circuit unit disposed inside the casing unit;
an output unit electrically connected to the circuit unit and exposed outside the casing unit; and
an antenna unit having a rotation element pivoting around the casing unit and an antenna disposed inside the rotation element and electrically connected to the circuit unit, wherein the rotation element is rotatably positioned at a first position close to the output unit and a second position far away from the output unit.

2. The digital TV receiver as claimed in claim 1, wherein the output unit is a USB connector.

3. The digital TV receiver as claimed in claim 1, wherein the rotation element has a pair of side arms, and the rotation element pivots around the casing unit via the pair of side arms.

4. The digital TV receiver as claimed in claim 1, wherein the rotation element has a U shape.

5. The digital TV receiver as claimed in claim 1, further comprising: a protection cover mated with the casing unit for covering the output unit.

6. The digital TV receiver as claimed in claim 5, wherein the first position is a retaining position for making the protection cover retained on the casing unit, and the rotation element is selectively positioned at the retaining position.

7. The digital TV receiver as claimed in claim 1, wherein the second position is an inclined position for making the rotation element inclined relative to the casing unit, and the rotation element is selectively positioned at the inclined position.

8. The digital TV receiver as claimed in claim 7, wherein the casing unit has a pair of inclined blocks for making the rotation element positioned at the inclined position.

9. The digital TV receiver as claimed in claim 1, wherein the casing unit has two sliding slots respectively formed on two sides thereof, and the rotation element has two sliding sides respectively disposed on the same end sides and slidably receiving in the two sliding slots.

10. The digital TV receiver as claimed in claim 9, wherein the rotation element has a receiving space formed on another opposite end side for mating with the casing unit and receiving the output unit.

11. The digital TV receiver as claimed in claim 10, wherein the first position is a covering position for making the output unit received in the receiving space of the rotation element, and the rotation element is selectively positioned at the covering position.
